(19) United States
(12) Patent Application Publication
(10) Pub. No.: US 2010/0190016 A1
(43) Pub. Date: Jul. 29, 2010

(54) PROCESS FOR THE PRODUCTION OF COMPOSITES COMPRISING MINERAL BODIES AND PLASTICS

(75) Inventors: Marcus Leberfinger, Georgsmarienhuette (DE); Oliver Reese, Lemfoerde (DE); Stephane Bezard, Den Haag (NL); Christian Hagen, Lemfoerde (DE); Hella Symolka, Damme (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/677,319

(22) PCT Filed: Sep. 10, 2008
(86) PCT No.: PCT/EP08/61984

§ 371 Date: Mar. 10, 2010

(30) Foreign Application Priority Data
Sep. 12, 2007 (EP) 07116199.6

(51) Int. Cl. B32B 9/04; B05D 1/36

(52) U.S. Cl. 428/446; 427/403

(57) ABSTRACT

The invention relates to a process for the production of composite bodies comprising mineral bodies and plastics, the liquid starting components of the plastics being applied to the surface of the mineral bodies where they cure to give the plastic, wherein cement is applied to the surface of the mineral bodies before the application of the liquid starting components of the plastics or as a mixture with said starting components.

The invention relates to composites comprising mineral bodies, in particular stones, and plastics, such as polyurethanes or epoxy resins. These composites preferably serve for consolidating rock beds, for example in the stabilization of traffic routes and in particular in coastal protection.

DE 10241293 describes a process for stabilizing banks, in which mineral surfaces of the banks, in particular loose stones, are bound with a hydrophobic polyurethane to give porous moldings. These composites are distinguished by high strength. Since the stones are not adhesively bonded to one another over their total area, the composites are porous. As a result, water can penetrate into the composite bodies and the energy of the waves is therefore reduced.

These composites are usually produced by applying the liquid starting components of the polyurethanes to the surface to be consolidated, where they cure to give the polyurethane. Owing to the hydrophobic nature of the polyurethanes, they can also cure under moist conditions, even under water. Nevertheless, it cannot be ruled out that foaming of the polyurethane takes place by the reaction with the moisture at least in individual areas, which may lead to impairment of the stability.

WO 2006/134136 describes a process for the production of such composites, in which the stones and the starting components of the plastics are introduced into a mixer and mixed there and this mixture is applied to the desired area, where the plastic cures. In this process, too, there is the problem that partial foaming of the plastic may occur owing to the moisture of the stones.

A further problem is to harden stones having different surface characteristics underwater. Different stone types (inter alia granites) have to date tended to repel the still uncured polyurethane layer on their surface underwater, so that adhesive bonding of the stones is not possible.

It was the object of the present invention to bind mineral bodies, in particular stones, with plastics to give moldings, the mineral bodies being brought into contact with the liquid starting components of the plastics and these then curing to give the plastic, whereby the curing should also be possible under moist conditions, also underwater, without the strength of the plastics being impaired. In particular, foaming of the plastics should be prevented. In addition, it should be possible to bind different mineral bodies, such as different stones or stones and concrete, to one another without an adverse effect. No compounds which may lead to soiling or danger to the environment should be used in the process.

It was surprisingly found that said problems can be solved if the stones are brought into contact with cement before the application of the liquid components of the plastics.

Accordingly, the invention relates to a process for the production of composite bodies comprising mineral bodies and plastics, the liquid starting components of the plastics being applied to the surface of the mineral bodies where they cure to give the plastic, wherein cement is applied to the surface of the mineral bodies before the application of the liquid starting components of the plastics or as a mixture with said starting components.

The mineral bodies may form a bank, a slope, an embankment or a structure.

Cement is preferably used in an amount such that the surface of the mineral bodies is substantially covered. In particular, from 0.5 to 5% by weight, preferably from 1.0 to 5% by weight, of cement, based in each case on the weight of the stones, is used.

All commercially available types, for example Portland cement, blast furnace cement, fast-setting cement or trass cement, may be used as cement.

As described, the plastics are those which are prepared from liquid starting components which cure to give solid plastics after mixing. Examples of these are polyurethanes and epoxy resins. The plastics are preferably compact, i.e. they comprise virtually no pores. Compared with cellular plastics, compact plastics are distinguished by a greater mechanical stability. Bubbles within the plastic may occur and are generally not critical. However, they should as far as possible be minimized.

In addition, it is preferable if the plastics are hydrophobic. As a result, degradation of the plastics by the water is suppressed.

The plastics are preferably used in an amount of from 0.5 to 5% by weight, based on the weight of the stones.

Regarding the polyurethanes which may be used, the following may be stated.

In the context of the present invention, components of the polyurethanes are understood as meaning very generally compounds having free isocyanate groups and compounds having groups which are reactive with isocyanate groups. Groups which are reactive with isocyanate groups are generally hydroxyl groups or amino groups. Hydroxyl groups are preferred since the amino groups are very reactive and the reaction mixture therefore has to be processed rapidly. The products formed by the reaction of these components are generally referred to below as polyurethanes.

Polyurethanes which may be used are the customary and known compounds of this type. These materials are prepared by reacting polyisocyanates with compounds having at least two active hydrogen atoms. In principle, all polyisocyanates, mixtures and prepolymers which are liquid at room temperature and have at least two isocyanate groups may be used as polyisocyanates.

Aromatic polyisocyanates, particularly preferably isomers of toluoylene diisocyanate (TDI) and of diphenylmethane diisocyanate (MDI), in particular mixtures of MDI and polyphenylene polymethylene polyisocyanates (crude MDI), are preferably used. The polyisocyanates may also be modified, for example by incorporation of isocyanurate groups and in particular by incorporation of urethane groups. The last-mentioned compounds are prepared by reacting polyisocyanates with less than the stoichiometric amount of compounds having at least two active hydrogen atoms and are usually referred to as NCO prepolymers. Their NCO content is in general in the range from 2 to 29% by weight.

In general, polyfunctional alcohols, so-called polyols, or, less preferably, polyfunctional amines are used as compounds having at least two hydrogen atoms reactive with isocyanate groups.

In a preferred embodiment of the process according to the invention, compact polyurethanes used are those which have been rendered hydrophobic. The hydrophobicity can be brought about in particular by addition of hydroxy-functional components customary in fat chemistry to at least one of the starting components of the polyurethane system, preferably to the polyol component.

A number of hydroxy-functional components customary in fat chemistry are known and may be used. Examples are castor oil, oils modified with hydroxyl groups, such as grape seed oil, black cumin oil, pumpkin seed oil, borage seed oil, soybean oil, wheat germ oil, rapeseed oil, sunflower oil, peanut oil, apricot kernel oil, pistachio oil, almond oil, olive oil, macadamia nut oil, avocado oil, sea buckthorn oil, sesame oil, hazelnut oil, evening primrose oil, wild rose oil, hemp oil, safflower oil, walnut oil, fatty acid esters modified with hydroxyl groups and based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid or cervonic acid. Castor oil and its reaction products with alkylene oxides or ketone-formaldehyde resins are preferably used here. The last-mentioned compounds are sold, for example, by Bayer AG under the name Desmophen® 1150 and by Cognis under the name Sovermol 805®.

A further preferably used group of polyols customary in fat chemistry can be obtained by ring-opening of epoxidized fatty acid esters with simultaneous reaction with alcohols and, if appropriate, subsequent further transesterification reactions. The incorporation of hydroxyl groups into oils and fats is effected in the main by epoxidation of the olefinic double bond present in these products, followed by the reaction of the resulting epoxide groups with a monohydric or polyhydric alcohol. The epoxide ring is converted into a hydroxyl group or, in the case of polyfunctional alcohols, into a structure having a larger number of OH groups. Since oils and fats are generally glyceryl esters, trans-esterification reactions also take place in parallel during the abovementioned reactions. The compounds thus obtained preferably have a molecular weight in the range from 500 to 1500 g/mol. Such products are available, for example, from Cognis.

In an embodiment of the process according to the invention, the compact polyurethane used is one which can be prepared by reacting polyisocyanates with compounds having at least two hydrogen atoms reactive with isocyanate groups, wherein the compounds having at least two reactive hydrogen atoms comprise at least one polyol customary in fat chemistry and at least one aromatic hydrocarbon resin modified with phenol, in particular an indene-coumarone resin. These polyurethanes and their components have such a high hydrophobicity that they can in principle cure even under-water. Preferably, indene-coumarone resins modified with phenol, particularly preferably industrial mixtures of aromatic hydrocarbon resins, are used as aromatic hydrocarbon resins modified with phenol and having a terminal phenol group, in particular those which comprise, as a substantial constituent, compounds of the general formula (I)

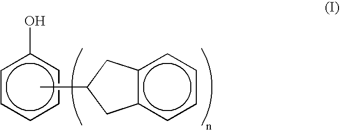

where n is from 2 to 28. Such products are commercially available and are offered, for example, by Rütgers VFT AG under the trade name NOVARES®. The aromatic hydrocarbon resins modified with phenol, in particular the indene-coumarone resins modified with phenol, generally have an OH content of from 0.5 to 5.0% by weight.

The polyol customary in fat chemistry and the aromatic hydrocarbon resin modified with phenol, in particular the indene-coumarone resin, are preferably used in a weight ratio of from 100:1 to 100:50.

Together with said compounds, it is possible to use further compounds having at least two active hydrogen atoms. Owing to their high resistance to hydrolysis, polyether alcohols are preferred. These are prepared by customary and known processes, generally by an additional reaction of alkylene oxides with H-functional initiators. The concomitantly used polyether alcohols preferably have a functionality of at least 3 and a hydroxyl number of at least 400 mg KOH/g, preferably at least 600 mg KOH/g, in particular in the range from 400 to 1000 mg KOH/g. They are prepared by a customary method by reacting at least trifunctional initiators with alkylene oxides. Initiators which may be used are preferably alcohols having at least three hydroxyl groups in the molecule, for example glycerol, trimethylolpropane, pentaerythritol, sorbitol or sucrose. A preferably used alkylene oxide is propylene oxide.

Further customary constituents may be added to the reaction mixture, for example catalysts and customary assistants and additives. In particular, drying agents, for example zeolites, should be added to the reaction mixture in order to avoid the accumulation of water in the components and hence foaming of the polyurethanes. These substances are preferably added to the compounds having at least two hydrogen atoms reactive with isocyanate groups. This mixture is frequently referred to in industry as polyol component. For improving the long-term stability of the composite substances, it is furthermore advantageous to add compositions which prevent attack by microbes. Moreover, the addition of UV stabilizers is advantageous for avoiding embrittlement of the moldings.

The polyurethanes used can in principle be prepared without the presence of catalysts. For improving the curing, catalysts may be concomitantly used. Catalysts preferably chosen should be those which result in as long a reaction time as possible. This makes it possible for the reaction mixture to remain liquid for a long time. As described, it is possible in principle also to work entirely without a catalyst.

The combination of the polyisocyanates with the compounds having at least two hydrogen atoms reactive with isocyanate groups should be effected in a ratio such that a stoichiometric excess of isocyanate groups, preferably of at least 5%, in particular in the range from 5 to 60%, is present.

The hydrophobic polyurethanes are distinguished by particularly good processability. Thus, these polyurethanes have particularly good adhesion, in particular to moist substrates, such as wet rock, in particular granite rubble. The polyurethanes cure in virtually compact form in spite of the presence of water. The compact polyurethanes used show completely compact curing even in thin layers.

In the context of this invention, epoxy resins are understood as meaning polymers which are obtained starting from compounds comprising epoxide groups, by polyaddition with suitable curing agents or polymerization via these epoxide groups. Epoxy resins according to the invention are preferably obtained by polyaddition with suitable curing agents.

Compounds which have at least two epoxide groups and are liquid at room temperature are preferably used as compounds comprising epoxide groups. It is also possible to use mixtures of different compounds comprising epoxide groups. These compounds are preferably hydrophobic or the mixtures comprise at least one compound comprising epoxide groups which is hydrophobic. Such hydrophobic compounds are obtained, for example, by a condensation reaction of bisphenol A or bisphenol F with epichlorohydrin. These compounds may be used individually or as mixtures.

In an embodiment, mixtures of the abovementioned hydrophobic compounds comprising epoxide groups with self-emulsifiable hydrophilic compounds comprising epoxide groups are used. These hydrophilic compounds are obtained by introducing hydrophilic groups into the main chain of the compound comprising epoxide groups. Such compounds and processes for their preparation are disclosed, for example, in JP-A-7-206982 and JP-A-7-304853.

Curing agents used are compounds which catalyze the homopolymerization of the compounds comprising epoxide groups or which react covalently with the epoxide groups or the secondary hydroxyl groups, such as polyamines, polyaminoamides, ketimines, carboxylic anhydrides and melamine, urea, phenol and formaldehyde adducts. Ketimines, obtainable by reacting a compound having primary or secondary amino groups, such as diethylenetriamine, triethylenetetramine, propylenediamine or xylylenediamine, with a carbonyl compound, such as acetone, methyl ethyl ketone or isobutyl methyl ketone, aliphatic, alicyclic and aromatic polyamine compounds and polyamide compounds, are preferably used. Ketimines or compatible mixtures comprising ketimines are particularly preferably used as curing agents.

The ratio of reactive groups in the curing agent to epoxide groups is preferably from 0.7:1 to 1.5:1, particularly preferably from 1.1:1 to 1.4:1.

Furthermore, in the preparation of the epoxy resins, further additives, such as solvents, reactive diluents, fillers and pigments, may be added in addition to the compounds comprising epoxide groups and the curing agents used. Such additives are known to the person skilled in the art.

Advantages of epoxy resin-based composite systems according to the invention are low costs and easy processability of the starting components of the epoxy resin. Furthermore, mixtures of the liquid starting components of the epoxy resin have a low viscosity, with the result that they can be easily mixed with the mineral bodies and economically metered. Further advantages of epoxy resin-based composite materials are high strength, corrosion resistance and good adhesion even to wet surfaces.

Preferably used mineral bodies are stones. These are particularly preferably rubble, in particular comprising granite, basalt or porphyry. The stones preferably have a size of from 0.1 to 50 cm, particularly preferably from 1 to 50 cm, more preferably from 1 to 20 cm, particularly preferably from 2 to 15 cm, in particular from 2 to 6.5 cm. In an embodiment of the invention, the stones are present in the form of loose beds before the application of the plastic. The beds may also comprise bodies whose size is greater than or less than the preferred size range. The beds are applied to the substrate to be stabilized. They may also be present between concrete surfaces, for example in the repair of stabilizations of banks. Here, it has been found that a strong bond between the stone beds and the concrete is permitted by the process according to the invention.

The thickness of the layer comprising the composite material is preferably at least 3 cm, particularly preferably at least 10 cm. Small layer thicknesses, in particular layer thicknesses less than 3 cm, frequently have only insufficient stability. The maximum thickness is dependent on the local circumstances and may be, for example, up to 5 meters.

As described, in the process according to the invention, cement and plastic, in particular polyurethane, can be brought into contact separately with the stones. For this purpose, first cement is applied to the surface of the stones and then the liquid starting components of the plastics are applied. It is also possible first to mix the cement with the liquid starting components of the plastics and to apply this mixture to the stones. In the case of the use of polyurethanes as plastics, the cement is preferably added to the components having at least two hydrogen atoms reactive with isocyanate groups. The ratio of cement to plastic is as stated above, the weight ratio of plastic to cement preferably being from 10:1 to 1:1, in particular about 1:1.

In a preferred embodiment of the process according to the invention, the application of the cement and of the liquid starting components of the plastics to the stones is effected in a mixer. Such a process is described, for example, in WO 2006/134136.

This process can be used both in the case of application of the stones above water and underwater. Particularly underwater, optimum curing, which is also virtually foam-free in the case of polyurethanes, can be effected by this embodiment of the process according to the invention.

In an embodiment, first the stones and the cement are introduced into the mixer. When stones and cement have been sufficiently mixed, the liquid starting components of the plastics are introduced into the mixer. After the mixing, the coated stones are applied to the desired area, where they cure to give the composite material. In another embodiment of this process, the stones and a mixture of cement and the liquid starting components of the plastics are introduced into the mixer.

In principle, all apparatuses with which substantially complete wetting of the mineral bodies with the liquid starting components of the plastic is possible can be used as mixers for mixing the stones with the starting components of the plastic. Mixers which consist of an open container, for example a drum, which is preferably provided with internals, have proven particularly suitable. For mixing, either the drum can be rotated or the internals can be moved.

Such mixers are known and are used, for example, in the building industry for the production of concrete mixes.

If the mixture is applied directly to the area to be stabilized, it may be advantageous to mount the mixer on a vehicle, for example a tractor, a front loader or a truck. In this embodiment of the process according to the invention, the mixture can be transported in each case to the place where it is to be applied. After emptying of the mixer, the mixture can be distributed manually, for example by means of rakes.

The time for the mixing should be at least sufficient for the mineral bodies to be wetted as completely as possible with the liquid mixture and at most so long that the plastic is still uncured.

In an embodiment of the process according to the invention, the mixing of the mineral bodies with the liquid starting components of the plastic is effected continuously. For this purpose, the mineral bodies, the cement and the liquid starting components of the plastic are introduced continuously into the mixer and the wetted mineral bodies are discharged continuously. In this procedure, it is necessary to ensure that the starting materials remain in the mixer until sufficient wetting of the mineral bodies can take place. Expediently, such a mixing apparatus can be moved along the sections to be stabilized at a speed such that the mineral bodies wetted with the liquid starting components of the plastic are applied from the mixer in an amount required for stabilization. It is also possible to operate the continuous mixing apparatus in a stationary manner and to transport the wetted mineral bodies discharged from the mixer to the desired location.

In a further embodiment of the continuous development of the process according to the invention, the mixer may be a rotating drum into which mineral bodies are continuously introduced. This drum is equipped with nozzles which continuously distribute the starting components of the plastics over the mineral bodies. Here, the rotation of the drum ensures thorough mixing of the plastic and mineral bodies. Plastic/mineral body composites are then discharged continuously through an opening at the end of the drum. The rotating drum may be horizontal or inclined at different angles in order to promote the discharge.

In a further embodiment of the continuous process, the mineral bodies are transported continuously on a conveyor belt which is moved through a tunnel. This has openings via which the starting materials of the plastic are discharged continuously onto the mineral bodies. At the end of the conveyor belt, the mineral bodies then fall into an open mixing drum which discharges the composite at an adjustable conveying speed.

It is also possible in principle to apply the loose stones in the desired thickness to the bank section to be stabilized and thereafter to apply first cement and then, by means of a suitable apparatus, for example a spray gun, the liquid starting components of the plastic, where they are distributed and cured. However, this procedure has the disadvantage that the distribution of the plastic is more nonuniform here and defects where no plastic is present cannot be ruled out. In particular, the distribution of the cement takes place only very incompletely. In this embodiment, deployment underwater is likewise not possible.

The thickness of the plastic layer on the mineral bodies is preferably from 0.5 mm to 1 cm, in particular from 0.5 mm to 3 mm.

In a preferred embodiment of the process according to the invention, sand can also be used, in addition to the stones, the plastic and the cement, for the production of the composites according to the invention.

In an embodiment of the invention, the sand can be applied to the surface of the composite material. To ensure that the sand adheres to the surface, the application of the sand should be effected before the complete curing of the plastic.

In a further embodiment, the sand, together with the liquid starting components of the plastic and/or the cement, can be mixed with the stones.

Any desired sands may be used. These may be natural sand or artificial sand, such as granulated blast furnace slag or ground slag.

In a preferred embodiment, quartz sand is used.

The particle size of the sand may vary within wide limits. The particle size is preferably in the customary range of 0.002-2 mm. Fine sand, i.e. that having a particle size of 0.06-0.2 mm, medium sand having a particle sand of 0.2-0.6 mm and/or coarse sand having a particle size of 0.6-2.0 mm are preferably used.

On application to the surface of the composite material, the amount of sand should be such that the surface of the composite material is substantially covered but blockage of the pores of the molding does not occur. The sand is preferably applied in an amount of from 2 to 4 kg/m² of the molding.

If the sand is added during the mixing of the stones with the liquid starting components of the plastic, the contact points between the mineral bodies, in particular the stones, are strengthened.

The rough surface produced by the sand promotes the settling of life forms, such as plants and mosses, on the applied composite material. This may be advantageous, for example, when the composite material is deployed in nature reserves. Furthermore, the sand improves the UV protection of the composite material.

Since the mineral bodies are bonded to one another substantially at the contact surfaces in the case of the composites according to the invention, gaps are formed and the composites are water-permeable. As a result of this, the energy with which the water strikes the rubble composite is better adsorbed by the escape of the water into cavities and does not lead to destruction of the composite material.

The invention is to be explained in more detail with reference to the following examples.

### EXAMPLE 1

20 g of Portland cement were added to 1 kg of dry basalt stones (22-32 mm particle size) in a stable vessel and thoroughly mixed. Thereafter, 20 g of a polyurethane resin prepared by stirring natural oils and polymer MDI (Lupranat® M20S from BASF AG) were added and thoroughly mixed for 3 minutes. The mixture was removed from the vessel and a part was cured in the air and a part underwater in a bucket for at least one day.

### EXAMPLE 2

20 g of Portland cement were added to 1 kg of moist basalt stones (22-32 mm particle size, stored beforehand in water) in a stable vessel and thoroughly mixed. Thereafter, 20 g of stirred polyurethane resin (Etastocoast® 6551/100 with Lupranat® M20S) were added thereto and thoroughly stirred for 3 minutes. The mixture was removed from the vessel and a part was cured in the air and a part underwater in a bucket for at least one day.

The composites from examples 1 and 2 had the same very good mechanical strength and were completely free of bubbles, regardless of whether the curing was effected in the air or underwater.

1. A process for the production of composite bodies comprising mineral bodies and plastics, the liquid starting components of the plastics being applied to the surface of the mineral bodies where they cure to give the plastic, wherein cement is applied to the surface of the mineral bodies before the application of the liquid starting components of the plastics or as a mixture with said starting components.

2. The process according to claim 1, wherein the plastics are polyurethanes.

3. The process according to claim 1, wherein the plastics are epoxy resins.

4. The process according to claim 1, wherein the mineral bodies are stones.

5. The process according to claim 1, wherein the cement is Portland cement, blast furnace cement, fast-setting cement or trass cement.

6. The process according to claim 1, wherein the cement is used in an amount of from 0.5 to 5% by weight, based on the weight of the stones.

7. The process according to claim 1, wherein the plastic is used in an amount of from 1 to 5% by weight, based on the weight of the stones.

8. The process according to claim 1, wherein first cement and then the liquid starting components of the plastics are applied to the surface of the mineral bodies.

9. The process according to claim 1, wherein the cement and the liquid starting components of the plastics are applied as a mixture to the surface of the mineral bodies.

10. The process according to claim 1, wherein the composite bodies additionally comprise sand.

11. A composite body comprising mineral bodies and plastics, which is produced according to claim 1.
